(19) United States
(12) Patent Application Publication
(10) Pub. No.: US 2009/0186420 A1
(43) Pub. Date: Jul. 23, 2009

(54) MICROELECTRONIC SENSOR DEVICE WITH WASHING MEANS

(75) Inventors: Josephus Arnoldus Henricus Maria Kahlman, Tilburg (NL); Menno Willem Jose Prins, Rosmalen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/302,903

(22) PCT Filed: May 22, 2007
(86) PCT No.: PCT/IB07/51928

§ 371 Date: Dec. 1, 2008

(30) Foreign Application Priority Data
Jun. 2, 2006 (EP) 06114897.9

(51) Int. Cl. G01N 27/00; G01N 21/00

(52) U.S. Cl. 436/150; 422/82.01; 422/82.05

(57) ABSTRACT

The invention relates to a microelectronic sensor device, particularly to a bio sensor with magnetic sensor units comprising excitation wires (11, 13) and a GMR sensor (12). The device further comprises a washing unit (20) consisting of a series of actuation wires (21) coupled to a driving unit (22). The driving unit (22) can activate the actuation wires selectively, wherein magnetic washing particles (2) are attracted to the activated wires. Shifting the activation pattern (R, S, T) then results in a corresponding movement of washing particles (2), which induces flow of the sample fluid that can wash away weakly bound and/or unbound target substance (3) from the sensor region (10) of the sensor units.

The invention relates to a microelectronic sensor device for measuring properties of a target substance in a sample fluid, comprising at least one sensor unit with an associated sensor region in which target substance can be immobilized. Moreover, it relates to the use of such a microelectronic sensor device and to a method for measuring properties of a target substance that is immobilized in a sensor region.

From the WO 2005/010543 A1 and WO 2005/010542 A2, a microelectronic sensor device is known which may for example be used in a microfluidic biosensor for the detection of molecules, e.g. biological molecules, labeled with magnetic beads.

From the US 2004/0219695 A1 it is further known to use magnetic or electric fields for attracting molecules labeled with magnetically or electrically interactive particles to binding sites and/or for removing unbound labeled molecules from a sensor region. A disadvantage of this approach is that the fields used for a removal act also directly on bound particles and have therefore a high probability to break existing bindings. Moreover, the effects of the fields are restricted to a relative small sensing region. Furthermore, said method does not wash (and refresh) non-magnetic target molecules and labels.

Based on this situation it was an object of the present invention to provide means for improving the accuracy of measurements of target substances in a fluid.

This objective is achieved by a microelectronic sensor device according to claim 1, by a method according to claim 14, and by a use according to claim 17. Preferred embodiments are disclosed in the dependent claims.

According to a first aspect, the invention relates to a microelectronic sensor device for measuring properties of a target substance in a sample fluid, for example of certain biochemical molecules in a biological body fluid. A target substance may particularly comprise a complex of a target molecule one it is interested in and of a label, for example a magnetic particle, that can be detected. In general, the term “target” has to be interpreted broadly in connection with the present invention. It can mean “target” in the narrower sense, i.e. the entity one is really interested in during the associated measurement; but it can also denote something that is only indirectly related to such a target in the narrower sense, e.g. a “target-analogue” (as for example in a competition assay) or “moiety derived from a target” (e.g. a fraction of a cell, or a moiety that has been enzymatically cleaved from an initial target). The sensor device comprises the following components:
a) At least one sensor unit with an associated (one-, two-, or three-dimensional) sensor region in which target substance can be immobilized, wherein the sensor unit is adapted to measure properties of target substance that is present in the sensor region (whether immobilized or not). The sensor can be any suitable sensor to detect the presence of magnetic particles on or near to a sensor surface, based on any property of the particles, e.g. it can detect via magnetic methods, e.g. magnetoresistive, Hall, coils. The sensor unit can detect via optical methods, for example imaging, fluorescence, chemiluminescence, absorption, scattering, surface plasmon resonance, Raman spectroscopy etc. Further, the sensor unit can detect via sonic detection, for example surface acoustic wave, bulk acoustic wave, cantilever deflections influenced by the biochemical binding process, quartz crystal etc. Further, the sensor unit can detect via electrical detection, for example conduction, impedance, amperometric, redox cycling, etc. In case a magnetic sensor unit is implemented, the sensor unit can be any suitable sensor unit based on the detection of the magnetic properties of particles to be measured on or near to the sensor unit surface. Therefore, the magnetic sensor unit is designable as a coil, magnetoresistive sensor unit, magneto-restrictive sensor unit, Hall sensor, planar Hall sensor, flux gate sensor, SQUID (Semiconductor Superconducting Quantum Interference Device), magnetic resonance sensor unit, or as another sensor unit actuated by a magnetic field.
b) A washing unit for moving magnetically or electrically interactive washing particles such that a flow of sample fluid and/or of washing particles is induced through the sensor region, wherein said flow can wash away weakly immobilized and/or non-immobilized target substance. Moreover, the flow can of course also wash away other substances from the sensor region, for example weakly bound and/or unbound labeling particles.

An advantage of the aforementioned microelectronic sensor device is that the sensor region can be freed from weakly bound and/or unbound target substance and other components that would interfere with the measurement of immobilized target substance one is actually interested in. The washing may particularly be used as a stringency step, in which the bound materials are put under stress to test the bindings for their strength and specificity. Thus a distinction can be made between signals due to weak and due to strong biochemical bindings. A further advantage of the device is that it makes use of washing particles and thus does not necessarily rely on the direct interaction of an electrical or magnetic field with target substance. Moreover, the washing unit can occupy an arbitrary large area which allows to generate a strong continuous or pulsated washing flow.

The ‘wash’ effect of the microelectronic sensor device is typically generated by at least one of the following different mechanisms:
1. The actuated entities, i.e. the entities that are electromagnetically moved, drag the fluid along with them. Subsequently, the movement of the fluid puts the materials bound to the sensor surface under stress via a shear force.
2. The actuated entities have collisions with the sensor surface, and thereby remove weakly bound material.
3. The actuated entities approach the sensor surface and exert a removal force on entities on the sensor surface. For example, the actuated entities can be magnetic particles and the entities on the sensor surface can be magnetic labels, while magnetic forces represent the removal forces (cf. WO 2005/010527 A1).
4. Once a material is loosened from the sensor surface, it can diffuse away into the bulk fluid. In case there is a too strong rate of unwanted materials attachment to the sensor surface, one can first replace the bulk fluid by a clean fluid and thereafter perform the wash procedure as proposed in this invention.

In a preferred embodiment of the invention, the washing unit is arranged in at least one closed loop for producing a cyclic flow in the sample fluid according to the form of the loop. The loop may comprise one or more sensor regions. An advantage of a predetermined cyclic flow is that it can be designed to be rather smooth such that it generates a collective movement with maximum speed.

The washing unit can at least partially be disposed in a layer that extends above or below the sensor unit. In this case the washing unit can reach with electrical or magnetic fields into the sensor region itself and is thus able to induce the flow of sample fluid and/or washing particles at the place where it is mostly required. It should be noted, however, that in general it is not necessary for the washing unit to affect washing particles in the sensor region itself as it suffices that the (elsewhere) induced flow affects the sensor region. Optionally there exists a sandwich structure of two such layers which extend below and above the sensor unit, respectively.

The washing unit can be realized in many different ways. In one preferred embodiment, the washing unit comprises a series of (geometrically) parallel conductor wires, called “actuation wires” in the following, that are coupled to a driver unit which is adapted to activate the actuation wires selectively, wherein an “activation” of a wire comprises the conduction of a driving current through it and/or the application of a driving voltage. The actuation wires may be straight or curved in their active zones (i.e. where they act on washing particles). The currents or voltages that are generated by the driver unit in the actuation wires will generate magnetic and/or electrical fields around the actuation wires which in turn exert forces on the washing particles for inducing their movement.

If the actuation wires are activated in a static way (i.e. with constant currents or voltages), the washing particles will move until they reach an energetically stable position. In order to achieve a continuous movement of washing particles, it is therefore preferred that the driving unit can shift the pattern of activated actuation wires in at least one direction along the series of actuation wires. The stable positions of the washing particles—and therefore the washing particles themselves—will then follow the shift of the pattern, resulting in the desired movement of washing particles along the series of actuation wires.

In the most simple case, the aforementioned pattern of activated actuation wires may consist of just one activated actuation wire among a rest of non-activated wires (or vice versa). In this case a single localized activation zone moves along the series of actuation wires. In order to generate more such activation zones and thus to increase the effectiveness of the washing unit, it is preferred that the pattern of activated actuation wires comprises a periodic repetition of a sub-pattern, wherein each sub-pattern represents a zone in which washing particles are actively moved.

In the embodiment with a shifted pattern of activated actuation wires, said pattern may preferably comprise a sub-pattern (whether periodically repeated or not) of at least two activated actuation wires separated by at least two neighboring inactive actuation wires. If such a sub-pattern is shifted by one wire at a time, this will uniquely generate a corresponding movement of washing particles in the shifting direction. If washing particles are for example attracted by the activated wires and therefore concentrate close to them, they will follow a shift of the activation to an immediately neighboring wire instead of making a jumping movement opposite to the shifting direction over one intermediate inactive wire. Generally speaking, a washing particle will follow the shifting direction of an activation pattern if, after each shift of the activation pattern, the actuation wire with the strongest attraction (i.e. usually the nearest active actuation wire) lies in the shifting direction.

In many cases the sensor units of microelectronic sensor devices comprise wires (i.e. more or less linear electrical conductors) through which currents can be conducted and/or to which voltages can be applied. In these cases it is preferred that at least one such wire of a sensor unit can also be operated as an actuation wire of the washing unit. The wire of the sensor unit will thus adopt a further functionality with respect to the generation of a movement of washing particles. This has the advantage that washing particles can be affected close to or in the sensor region without a need for additional hardware.

In the aforementioned case, the wire of the sensor unit is typically arranged parallel to the (usual) actuation wires of the washing unit in order to be seamlessly integrated into their series. In another embodiment of a microelectronic sensor device with sensor units that comprise at least one wire, the actuation wires are arranged at an angle with respect to said wire of the sensor unit. In this case the wire of the sensor unit usually cannot be used as an actuation wire of the washing unit, but there is also less interference between the normal operation of said sensor unit wire and the actuation wires of the washing unit. A minimization of said interference is generally achieved if the actuation wires of the washing unit are arranged perpendicular to the sensor unit wire.

In another particular embodiment of the microelectronic sensor device, the sensor unit comprises at least one magnetic excitation wire for generating a magnetic field in the sensor region. Such an excitation wire can for example be used to magnetize labeling beads which are bound to target molecules. As described above, the magnetic excitation wire can optionally be integrated into the function of the washing unit.

The microelectronic sensor device may for example comprise optical, magnetic, mechanical, acoustic, thermal and/or electrical sensor units. Some of these sensor concepts are described in the WO 93/22678, which is incorporated into the present text by reference. A microelectronic sensor device with magnetic sensor units is for example described in the WO 2005/010543 A1 and WO 2005/010542 A2, which are also incorporated into the present text by reference. Said device is used as a microfluidic biosensor for the detection of biological molecules labeled with magnetic beads. It is provided with an array of sensor units comprising wires for the generation of a magnetic field and magneto-resistive elements for the detection of stray fields generated by magnetized beads. The magneto-resistive element may especially be a GMR (Giant Magneto Resistance), a TMR (Tunnel Magneto Resistance), or an AMR (Anisotropic Magneto Resistance). The magnetic sensor element might also be realized by a Hall sensor.

The sensor region preferably comprises a surface covered with binding sites for target substance, wherein the specificity of said binding guarantees that only desired (target) substances are immobilized by the binding sites. If other substances than the proper target substance are occasionally bound by the binding sites, they will in general be removed during the washing step that is possible due to the washing unit of the sensor device.

The invention further relates to a method for measuring properties of a target substance in a sample fluid, wherein said method comprises the following steps:
a) Immobilizing target substance in a sensor region, for example by (bio)chemically binding it to binding sites on the surface of said sensor region.
b) Measuring properties of target substance that is present in the sensor region (whether immobilized or not), wherein said measurement is typically done by an associated sensor unit.
c) Moving magnetically or electrically interactive washing particles such that a flow of sample fluid and/or of washing particles is induced through the sensor region which can wash away immobilized target substance before and/or during the measurement of step b).

The method comprises in general form the steps that can be executed with a microelectronic sensor device of the kind described above. Therefore, reference is made to the preceding description for more information on the details, advantages and improvements of that method.

According to a preferred embodiment of the method, the washing particles are moved by a shifting pattern of electrical or magnetic fields, wherein the shifting velocity has to be adjusted appropriately to the possible moving velocity of the washing particles. Typical shifting velocities range from 1 μm/s to 100 μm/s.

As was already mentioned, the target substance may be any (pure or composite) material that shall be measured or detected. The target substance may especially comprise magnetically or electrically interactive labeling particles that are bound to some sample material, wherein one is actually interested in the properties (e.g. the concentration) of that sample material and uses the labeling particles only as a means for manipulating or detecting it. Detection can be based on magnetic properties, optical properties, electrical properties, mass properties, acoustic properties, thermal properties, etc. The labeling particles may particularly be of the same kind as the washing particles, for example be magnetic beads. Labeling and washing particles may however also be different and interact for example electrically and magnetically, respectively (or vice versa).

The invention further relates to the use of the microelectronic sensor device described above for molecular diagnostics, biological sample analysis, or chemical sample analysis. Molecular diagnostics may for example be accomplished with the help of magnetic beads that are directly or indirectly attached to target molecules.

The described method and the microelectronic sensor device can be applied in connection with several types of assays, e.g. sandwich assay, competitive assay, inhibition assay, displacement assay, assay with sequential fluidic process steps, or a single-shot assay in which the fluid is not replaced.

These and other aspects of the invention will be apparent from and elucidated with reference to the embodiment(s) described hereinafter. These embodiments will be described by way of example with the help of the accompanying drawings in which:

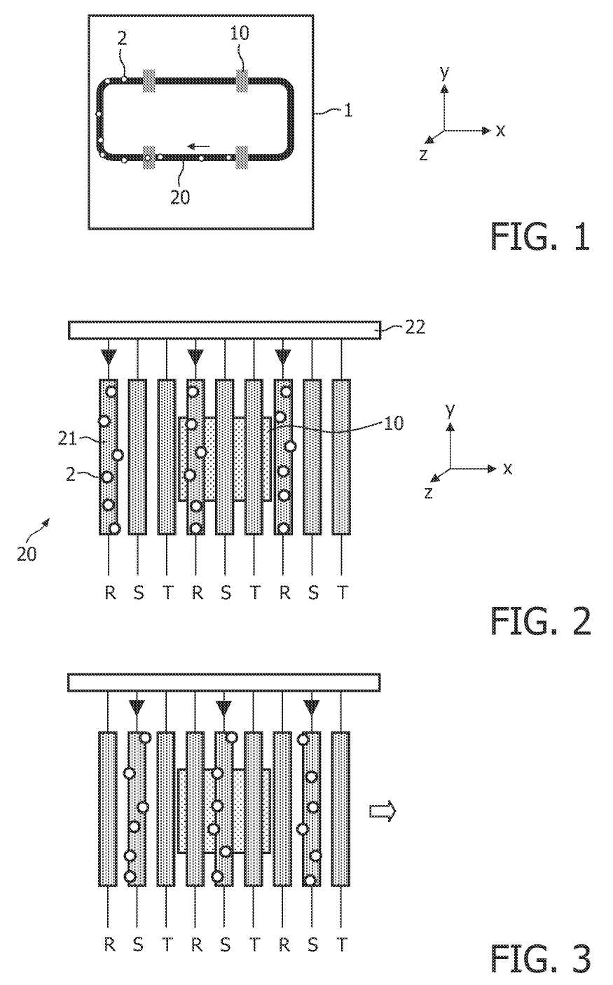

FIG. 1 shows a schematic top view of a microelectronic sensor device according to the present invention with a washing unit arranged in a closed loop;

FIG. 2 shows schematically a series of actuation wires forming a part of a washing unit, wherein said wires are activated in a certain pattern;

FIG. 3 shows the actuation wires of FIG. 2 after the activation pattern has been shifted by one wire to the right;

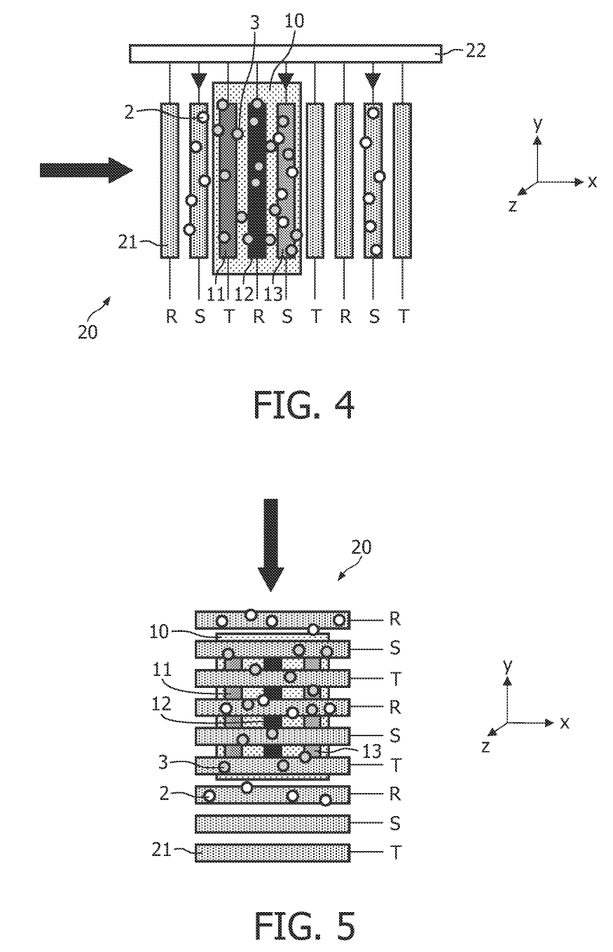

FIG. 4 shows schematically a series of actuation wires forming a part of a washing unit, wherein magnetic excitation wires and a GMR sensor of a magnetic sensor unit are integrated into said series;

FIG. 5 shows a perpendicular arrangement of actuation wires of a magnetic washing unit and wires of a magnetic sensor unit.

Like reference numbers in the Figures refer to identical or similar components.

Though the present invention can be applied to many kinds of microelectronic sensor devices that make for example use of optical or electrical detection principles, it will be described in the following with reference to magnetic sensor devices. Such magnetic sensor devices may particularly be applied as a biosensor for the detection of magnetically interactive particles, e.g. superparamagnetic beads, in a sample chamber. Magneto-resistive biochips or biosensors have promising properties for bio-molecular diagnostics, in terms of sensitivity, specificity, integration, ease of use, and costs. Examples of such biochips are described in the WO 2003/054566, WO 2003/054523, WO 2005/010542 A2, WO 2005/010543 A1, and WO 2005/038911 A1, which are incorporated into the present application by reference.

An important assay step in a (e.g. magnetic) biosensor is the so-called stringency step, in which a distinction is made between signals due to weak and due to strong biochemical bindings. In such a step, the bound materials are put under stress and tested for the strength and specificity of their binding. In state-of-the-art systems, stringency is usually applied by a washing step at the endpoint of the assay. This step cannot easily be transferred to a rapid and cost-effective biosensor, because the method requires a washing solution and mechanical pumping or valving.

Besides sensitivity, speed is also important for an assay. In a high-speed biosensor system (e.g. drugs-of-abuse testing in saliva), the kinetics of the binding process may be analyzed in order to perform a rapid measurement. Therefore, the washing step should be easily repeatable.

It is therefore an aim of the present invention to make an assay more sensitive and faster by providing a simple and repeatable stringency method, which allows particularly intermittent measurements during the binding steps in a biosensor.

The solution proposed here comprises the use of on-chip magnetic excitation for a washing step, wherein the washing step comprises moving magnetic beads across a sensor surface to wash away non-specific and un-bonded materials, e.g. target molecules, labels and beads. The shear forces, the collisions with the surface, and the non-specific interactions between washing beads and moving fluid and the surface are used in this approach to put the bound material under stringency. The method realizes inter alia (1) liquid flow, (2) impact from moving beads on other beads, and (3) cluster and chain forming of beads. The proposed on-chip magnetic excitation is most (or even only) effective close to the surface, where the magnetic field strength (gradient) is high. It should be noted that the idea is generic for a wide variety of biosensor systems (optical detection, magnetic detection, electrical detection, etc.). Moreover, it can be generalized to the movement of electrically interactive particles instead of magnetic beads.

FIG. 1 shows schematically the chip area 1 of a microelectronic sensor device in a top view. The sensor device comprises a plurality of (e.g. magnetic) sensor units with sensitive sensor regions 10 on the chip surface, wherein just four of a possibly large number of such sensor regions are depicted in the Figure. Typically, the sensor regions 10 are coated with (the same or different) binding sites, e.g. antibodies, to which target molecules of interest can bind. During a measurement, the chip surface is contacted with a sample fluid comprising one or more types of target molecules, which will then specifically bind to the aforementioned binding sites and will thus be immobilized in the sensor regions.

FIG. 1 further shows a washing unit 20 which is arranged here as a closed loop on the chip surface and which crosses the four sensor regions 10. The washing unit 20 exerts a magnetic force on magnetically interactive washing particles or beads 2 in the direction of the loop (arrow). This results in a cyclic movement of the washing beads 2 along the course of the washing unit 20, which induces a corresponding cyclic flow of sample fluid in a sample chamber above the chip surface. As this flow crosses the sensor regions 10, it is able to wash away weakly bound or unbound materials from there. As was already mentioned, the described principles could mutatis mutandis be realized with an electrical washing unit affecting electrically interactive particles.

The washing unit or “bead motor” can particularly be realized by a plurality of actuation wires which are actuated in time-multiplex, e.g. like a N-phase linear motor acting as a conveyor belt. FIG. 2 shows this schematically for an enlarged section of the washing unit 20. The washing unit 20 comprises a series of parallel actuation wires 21 which are coupled to a driving unit 22, wherein the washing unit 20 and its direction of action (x-direction) extend perpendicular to the actuation wires 21 (y-direction). A sensor region 10 which is crossed by the washing unit 20 is also indicated in the Figure.

The driving unit 22 can drive or “activate” the actuation wires 21 individually or in groups. Typically, said activation comprises the conducting of a current of a predetermined magnitude through an actuation wire 21, wherein non-activated actuation wires are current-free. In the particular case of FIG. 2, the series of actuation wires 21 is activated according to a periodic pattern consisting of sub-patterns with three neighboring actuation wires that are denoted by the letters R, S, and T. All actuation wires 21 belonging to one letter, i.e. R, S, or T, are activated simultaneously and are therefore preferably connected collectively to the driving unit 22 to minimize the number of pins. In the phase shown in FIG. 2, only the actuation wires R are activated, while the actuation wires S and T are inactive. The magnetic washing particles 2 are therefore magnetically attracted to the activated actuation wires R.

FIG. 3 shows the next phase in which the driving unit 22 has shifted the activation pattern by one wire to the right (cf. arrow). This means that now the actuation wires S are activated while actuation wires R and T are inactive. The magnetic beads will then follow the activation pattern to the right and concentrate above the now active actuation wires S. It should be noted that such a unique following movement is possible because the gap between two active actuation wires is more than twice as wide as the distance by which the activation pattern jumps. Starting from their initial position of FIG. 2, the magnetic beads 2 are therefore, after a jump of the activation pattern to the right by one wire, more strongly attracted to the right than to the left.

In the next phase, the actuation wires T are activated resulting in a further movement of the washing beads 2 to the right. Thus the repetitive activation of the actuation wires 21 in the cyclic sequence R-S-T-R-S-T . . . will generate a continuous movement of washing beads 2 in the shifting direction. The shifting direction can be reversed if the actuation wires are activated in the inverse sequence R-T-S-R-T-S. . . . In this way a kind of linear bead motor is realized for moving magnetic beads 2 across the chip surface and in particular over the sensor regions 10. The movement of magnetic beads 2 introduces a constant laminar fluid flow across said sensor regions 10. As a result un-bonded beads 2 are automatically washed away from the sensitive area of each sensor.

While FIGS. 2 and 3 indicate a simultaneous activation of corresponding actuation wires (e.g. of all R wires), it is also possible to activate these wires in a time-multiplexed manner, i.e. one after the other. In this case the driving unit 22 can drive or “activate” each actuation wire 21 individually. Time multiplexing reduces the total power dissipation on the sensor chip, as a minimum attracting force (current) is needed to overcome the Brownian motion of the beads. Furthermore it may avoid magnetic clustering (the forming of chains) if the on-time (duty cycle) is relatively short compared to the time needed for clustering. It can be applied to all embodiments described in this disclosure.

FIG. 4 shows the series of actuation wires 21 of the washing unit 20 in the particular case where the sensor unit is a magnetic sensor comprising two magnetic excitation wires 11, 13 and a magneto-resistance, for example a GMR wire 12. A target substance comprising magnetic labeling beads 3 is immobilized in the sensor region 10 of said sensor unit, for example by binding to corresponding antibodies on the sensor surface. The immobilized beads 3 may be different from the kind of particles used as washing beads 2, or they may be the same.

As FIG. 4 indicates, the three sensor wires 11, 12, 13 are seamlessly integrated into the series of actuation wires 21 of the washing unit 20. This means that they are additionally coupled to the driving unit 22, which can drive them just like “normal” actuation wires 21 of the washing unit (e.g. in an R-S-T pattern) for generating a continuous flow of washing beads 2. Ideally, the actuation wires 21 and the wires 11, 12, 13 of the GMR sensor unit are vertically aligned in one layer such that the magnetic cross talk between them is minimized.

FIG. 5 shows an alternative embodiment of a sensor device with a magnetic sensor unit comprising magnetic excitation wires 11, 13 and a GMR wire 12. In this case, the actuation wires 21 of the washing unit 20 are arranged perpendicular to the wires 11, 12, and 13 of the sensor unit. This avoids undesired magnetic fields in the sensitive direction of the GMR sensor 12 and realizes a bead movement in the y-direction.

While in the embodiment of FIG. 4 the actuation wires 21 and the sensor wires 11, 12, 13 are preferably arranged in the same plane, the actuation wires 21 in the embodiment of FIG. 5 are arranged above or below the sensor wires 11, 12, 13. Moreover, actuation wires 21 may be positioned in a sandwich structure above and below the GMR sensor unit, such that the magnetic field from the actuation wires 21 in the y-direction compensates.

A microelectronic sensor device of the kind described above has the advantage to allow on-chip bead manipulation for easy cartridge and reader implementation. It achieves an efficient bead transport over the sensor area, and it is compatible with several types of assays.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic sensor device for measuring properties of a target substance (3) in a sample fluid, comprising
a) at least one sensor unit with an associated sensor region (10) in which target substance (3) can be immobilized;
b) a washing unit (20) for moving magnetically or electrically interactive washing particles (2) such that a flow of sample fluid and/or of washing particles (2) is induced through the sensor region (10) which can wash away weakly immobilized and/or non-immobilized target substance (3).

2. The microelectronic sensor device according to claim 1,
characterized in that the washing unit (20) is arranged in at least one closed loop for producing a cyclic flow in the sample fluid.

3. The microelectronic sensor device according to claim 1,
characterized in that the washing unit (20) is at least partially disposed in a layer that extends above or below the sensor unit.

4. The microelectronic sensor device according to claim 1,
characterized in that the washing unit (20) comprises a series of parallel actuation wires (21) coupled to a driving unit (22) for activating them selectively by conducting a driving current through them and/or by applying a voltage to them.

5. The microelectronic sensor device according to claim 4,
characterized in that the driving unit (22) is adapted to shift a pattern (R, S, T) of activated actuation wires (21) in at least one direction along the series of actuation wires.

6. The microelectronic sensor device according to claim 5,
characterized in that the pattern comprises a periodic repetition of the sub-pattern (R, S, T).

7. The microelectronic sensor device according to claim 5,
characterized in that the pattern comprises a sub-pattern (R, S, T, R) of at least two activated actuation wires (R) separated by at least two neighboring inactive actuation wires (S, T).

8. The microelectronic sensor device according to claim 1,
characterized in that the sensor unit comprises at least one wire (11, 12, 13) that can be operated as a actuation wire of the washing unit (20).

9. The microelectronic sensor device according to claim 1,
characterized in that the actuation wires (21) are arranged at an angle with respect to at least one wire (11, 12, 13) of the sensor unit.

10. The microelectronic sensor device according to claim 1,
characterized in that the sensor unit comprises at least one magnetic excitation wire (11, 13) for generating a magnetic field in the sensor region (10).

11. The microelectronic sensor device according to claim 1,
characterized in that it comprises at least one optical, magnetic, mechanical, acoustic, thermal or electrical sensor unit.

12. The microelectronic sensor device according to claim 1,
characterized in that the sensor unit comprises a Hall sensor or a magneto-resistive element like a GMR (12), a TMR, or an AMR element.

13. The microelectronic sensor device according to claim 1,
characterized in that the sensor region (10) comprises a surface covered with binding sites for target substance (3).

14. A method for measuring properties of a target substance (3) in a sample fluid, comprising the following steps:
a) immobilizing target substance (3) in a sensor region (10);
b) measuring properties of target substance (3) that is present in the sensor region (10);
c) moving magnetically or electrically interactive washing particles (2) such that a flow of sample fluid and/or of washing particles (2) is induced through the sensor region (10) before and/or during step b), wherein said flow can wash away non-immobilized target substance (3).

15. The method according to claim 14,
characterized in that the washing particles (2) are moved by a shifting pattern of electrical or magnetic fields.

16. The method according to claim 14,
characterized in that the target substance (3) comprises magnetically or electrically interactive labeling particles, which are optionally of the same kind as the washing particles (2).

17. Use of the microelectronic sensor device according to claim 1 for molecular diagnostics, biological sample analysis, or chemical sample analysis.
